(19) United States
(12) Patent Application Publication
(10) Pub. No.: US 2019/0162066 A1
(43) Pub. Date: May 30, 2019

(54) FLUID ANALYSIS TOOL AND METHOD TO USE THE SAME

(71) Applicant: HALLIBURTON ENERGY SERVICES, INC., Houston, TX (US)

(72) Inventors: Dingding CHEN, Tomball, TX (US); Christopher Michael JONES, Houston, TX (US); Darren GASCOOKE, Houston, TX (US)

(73) Assignee: HALLIBURTON ENERGY SERVICES, INC., Houston, TX (US)

(21) Appl. No.: 16/321,515

(22) PCT Filed: Sep. 20, 2016
(86) PCT No.: PCT/US2016/052656

§ 371 Date: Jan. 29, 2019

(51) Int. Cl. E21B 49/08; E21B 47/00; E21B 41/00; G06N 5/04; G06N 3/02

(52) U.S. Cl. CPC E21B 49/08; E21B 47/0002; E21B 41/00; E21B 2041/0028; G06N 3/02; E21B 2049/085; G06N 5/048

(57) ABSTRACT

A method includes obtaining a measurement of one or more properties of a downhole fluid using a fluid analysis tool. The fluid analysis tool includes fluid sensors and one or more processors coupled with the fluid sensors. A first prediction is generated using the measurement from the fluid sensors. A second prediction is generated using an adaptive neuro-fuzzy inference system based on the first prediction of the properties.

### FIELD

The present disclosure relates to fluid analysis in oil and gas operations, and more specifically to enhancing optical fluid analysis with an adaptive neuro-fuzzy inference system and method.

### BACKGROUND

Wellbores are drilled into the earth for a variety of purposes including accessing hydrocarbon bearing formations. A variety of downhole tools may be used within a wellbore in connection with analyzing the downhole fluids. Optical sensors can be utilized to determine different properties and compositions such as density, gas:oil ratio, saturates, and concentrations of C1-C5 hydrocarbons. Throughout the process, it may become necessary to predict the composition or characterization of the fluids, which can include formation fluid. Using the determined properties from the optical sensors, models such as neural network ensembles can provide predictions of the formation fluid. The predictions from the models are prepared by analyzing the data using processors that are calibrated by measurements from a laboratory under similar pressure, temperature, and volume (PVT). Often, to achieve a more refined prediction, the data collected by the optical sensors is sent off site for post-processing.

### BRIEF DESCRIPTION OF THE DRAWINGS

Implementations of the present technology will now be described, by way of example only, with reference to the attached figures, wherein:

FIG. 1A is a diagram illustrating an exemplary environment for a fluid analysis tool while drilling a wellbore according to the present disclosure;

FIG. 1B is a diagram illustrating an exemplary wireline environment for a fluid analysis tool;

FIG. 2 is a diagram illustrating an exemplary system;

FIGS. 3A-3E are diagrams illustrating exemplary cross plots of properties against concentration of saturates to be predicted from an exemplary database;

FIG. 4 is a diagram illustrating an exemplary adaptive neuro-fuzzy inference system model;

FIGS. 5A-5B are diagrams illustrating exemplary membership functions;

FIG. 6 is a diagram illustrating an exemplary cross plot of an adaptive neuro-fuzzy inference system model predicted saturate concentration against saturate concentration from an exemplary database; and

FIG. 7 is a flow chart illustrating an exemplary method for utilizing the fluid analysis tool.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

In the above description, reference to up or down is made for purposes of description with “up,” “upper,” “upward,” “uphole,” or “upstream” meaning toward the surface of the wellbore and with “down,” “lower,” “downward,” “downhole,” or “downstream” meaning toward the terminal end of the well, regardless of the wellbore orientation. Correspondingly, the transverse, axial, lateral, longitudinal, radial, etc., orientations shall mean orientations relative to the orientation of the wellbore or tool. The term “axially” means substantially along a direction of the axis of the object. If not specified, the term axially is such that it refers to the longer axis of the object.

Several definitions that apply throughout the above disclosure will now be presented. The term “coupled” is defined as connected, whether directly or indirectly through intervening components, and is not necessarily limited to physical connections. The connection can be such that the objects are permanently connected or releasably connected. The term “outside” or “outer” refers to a region that is beyond the outermost confines of a physical object. The term “inside” or “inner” refers to a region that is within the outermost confines of a physical object. The term “substantially” is defined to be essentially conforming to the particular dimension, shape or other word that substantially modifies, such that the component need not be exact. For example, “substantially cylindrical” means that the object resembles a cylinder, but can have one or more deviations from a true cylinder. The terms “comprising,” “including” and “having” are used interchangeably in this disclosure. The terms “comprising,” “including” and “having” mean to include, but not necessarily be limited to the things so described.

Disclosed herein is a method and system for downhole fluid analysis. A fluid analysis tool, for example a HALLIBURTON® RESERVOIR DESCRIPTION TOOL (RDT™), includes one or more fluid sensors, a first processor, and a second processor. The fluid analysis tool is provided to a desired location within a wellbore by wireline where the fluid sensors obtain a measurement of one or more properties of a downhole fluid. The fluid sensors can be optical sensors, such as HALLIBURTON® ICE CORE® analyzers. The one or more properties that are measured can be, for example and are not limited to, C1-C5 hydrocarbon concentration, gas:oil ratio, sum of SARA (saturates, aromatics, resins, and asphaltenes) concentration, positive correlated saturates, or negative correlated saturates.

After the measurements are taken by the fluid sensors, one or more processors generates a first prediction of the properties of the downhole fluid in real time using the measurements from the fluid sensors. The processor can use, for example, a neural network ensemble. To enhance the first prediction, the second processor, also in real time, uses an adaptive neuro-fuzzy inference system (ANFIS) to generate a second prediction of the properties based on the first prediction. To supplement and train the ANFIS, fluid data which is stored on a non-transitory computer-readable storage medium is utilized. The fluid data can be obtained from an optical-PVT (pressure-volume-temperature) database. The overall characterization of the downhole fluid is thus enhanced without post-processing of the measurements obtained from the fluid sensors.

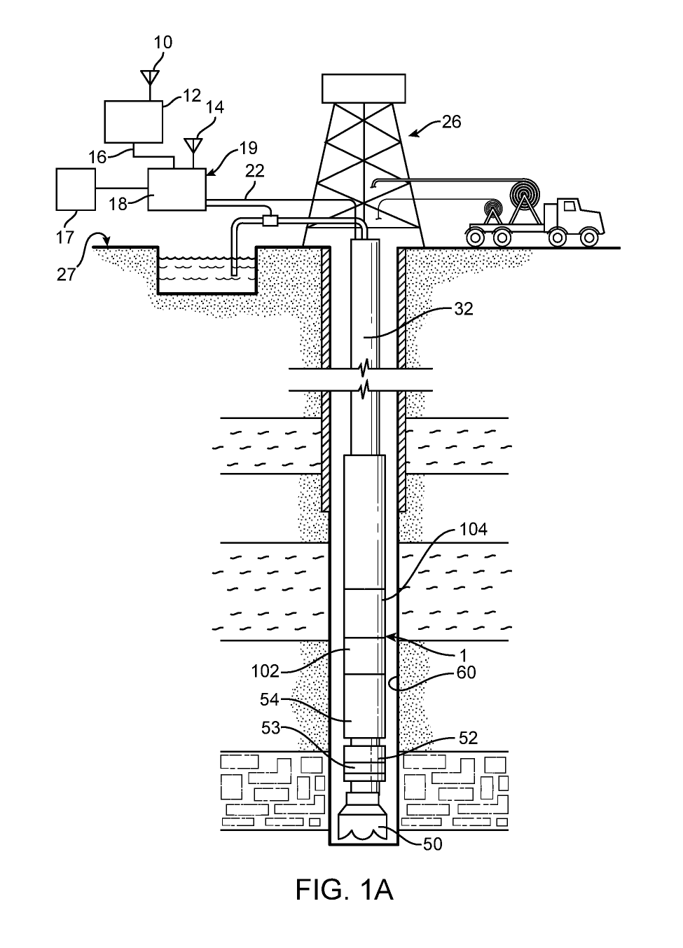

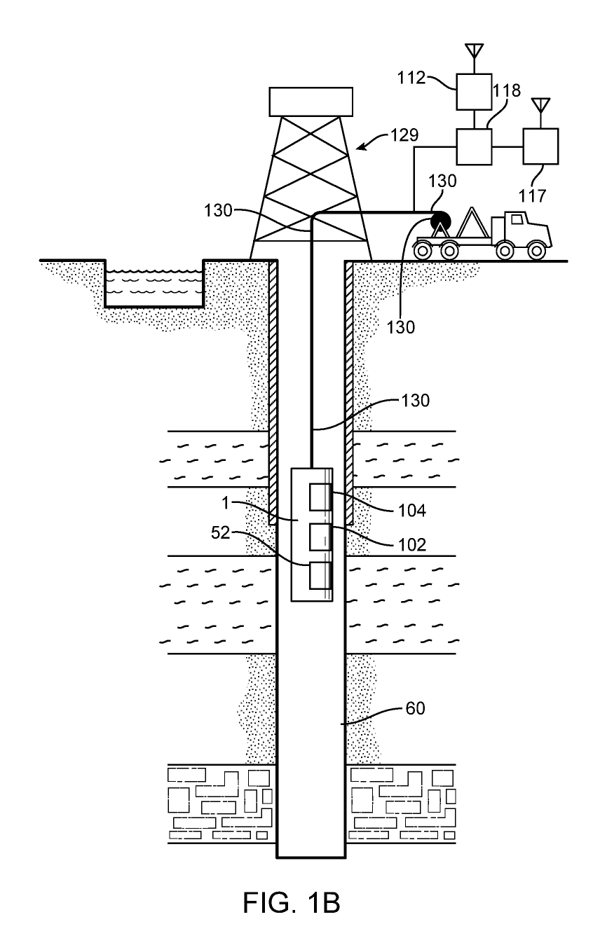

As shown in FIG. 1A, the drill string 32 supports several components along its length. One or more fluid sensors 52, a first processor 102, and a second processor 104 are included in a fluid analysis tool. The fluid analysis tool can be a tool with optical sensors, for example a HALLIBURTON® RDT™. The one or more fluid sensors 52 detect and measure conditions near the drill bit 50, conditions which can include such properties as formation fluid density, temperature and pressure, and azimuthal orientation of the drill bit 50 or string 32. The fluid sensors 52 can be optical sensors. In other examples, the fluid sensors 52 can be analyte specific broadband filters, for example HALLIBURTON® ICE CORE® sensors. The first processor 102 is communicatively coupled to the fluid sensors 52. Along with the first processor 102 and the second processor 104, the fluid analysis tool 1 includes a first non-transitory computer-readable storage medium that has first instructions stored which are executed by the first processor 102. In at least one example, the first processor 102 uses a neural network ensemble. In a neural network ensemble, multiple neural networks are created and combined to produce a desired output. In other examples, only one neural network is used. The second processor 104 is communicatively coupled to a second non-transitory computer-readable storage medium and, in at least one example, is communicatively coupled to the fluid sensors 52. In other examples, the second processor 104 is communicatively coupled with the first processor 102. The second non-transitory computer-readable storage medium has second instructions stored which are executed by the second processor 104. The second non-transitory computer-readable storage medium can be communicatively coupled with the first processor 102. In at least one example, the second processor 104 uses an adaptive neuro-fuzzy inference system (ANFIS). While the disclosure below generally refers to a first processor and a second processor, the methods can be conducted using one processor. Similarly, the methods can be conducted using one non-transitory computer-readable storage medium.

Additionally, measurement while drilling (MWD)/logging while drilling (LWD) procedures are supported both structurally and communicatively. The fiber optic communications as disclosed herein can be suitably employed for wireline communication operations of MWD, LWD, slickline, and/or coiled tubing configurations, and can be conducted by fiber optic cable located within the well bore 48 or within the drill string 32. The fluid sensors 52 can detect characteristics of the downhole fluid within the wellbore 48 proximate the fluid sensors 52 which can include, but are not limited to, C1-C5 hydrocarbon concentration, gas:oil ratio, sum of SARA (saturates, aromatics, resins, and asphaltenes) concentration, positive correlated saturates, negative correlated saturates, CO₂, H₂O, synthetic drilling fluid, fluid density, or API gravity. Regardless of which conditions or characteristics are sensed, data indicative of those conditions and characteristics is recorded downhole in real time for communication to the surface by fiber optic communications as disclosed herein. In other examples, the data can be sent to a local processor 18 where the data may be either processed or further transmitted along to a remote processor 12 via wire 16 or wirelessly via antennae 14 and 10.

The fluid sensors 52 can be located along the drill string 32 above the drill bit 50. The fluid sensors 52 can carry a signal processing apparatus 53 for transmitting, receiving, modulating, and otherwise processing signals passing along drill string 32 to and from the surface 27 via a communication path 22. Additional sensor sub-units 35 can be included as desired in the drill string 32. The fluid sensors 52 positioned below the motor 46 has apparatus 53 to relay information to the surface 27. Communication between the apparatus 53 below the motor 46 and the fluid analysis tool 1 can be accomplished by use of a short hop telemetry system or by the fiber optic cabling, or other commercially suitable communication means.

As shown in FIG. 1A, the surface installation 19 includes a transceiver (antennae) 14 that can communicate with the surface sensor sub-unit 35, the personal computer 18 coupled to the transceiver 14 for processing the signals from the fluid sensors 52 and the sensor sub-units 35, and a real-time clock 17 for time-stamping signals and sensor data from the sensor sub units. Power for the sensor sub-units and communication apparatuses in the sub-units may be provided as is known in the art.

As illustrated in FIG. 1B, the fluid analysis tool 1 can be employed with “wireline” systems, in order to carry out logging or other operations. For example, instead of using the drill string 32 of FIG. 1A to lower fluid analysis tool 1, fluid analysis tool 1 can be lowered into the wellbore 48 by wireline conveyance 130 as shown in FIG. 1B. As in FIG. 1A, the fluid analysis tool 1 contains the fluid sensors 52, the first processor 102, and the second processor 104. The wireline conveyance 130 can be anchored in the drill rig 129 or portable means such as a truck. The wireline conveyance 130 can be one or more wires, slickline, cables, or the like, as well as tubular conveyances such as coiled tubing, joint tubing, or other tubulars. The illustrated wireline conveyance 130 provides support for the tool, as well as enabling communication between the tool processors on the surface and providing a power supply. The wireline conveyance 130 can include fiber optic cabling for carrying out communications. The wireline conveyance 130 is sufficiently strong and flexible to tether the fluid analysis tool 1 through the wellbore 48, while also permitting communication through the wireline conveyance 130 to local processor 118 and/or remote processors 112, 117. Additionally, power can be supplied via the wireline conveyance 130 to meet power requirements of the tool. For slickline or coiled tubing configurations, power can be supplied downhole with a battery or via a downhole generator.

It should be noted that while FIGS. 1A-1B generally depict a land-based operation, those skilled in the art would readily recognize that the principles described herein are equally applicable to operations that employ floating or sea-based platforms and rigs, without departing from the scope of the disclosure. Also, even though FIGS. 1A-1B depict vertical wellbores, the present disclosure is equally well-suited for use in wellbores having other orientations, including horizontal wellbores, slanted wellbores, multilateral wellbores or the like. Further, the fluid analysis tool 1 can be used in a wellbore 60 with a casing already implemented while, in other examples, the fluid analysis tool 1 can be used in open hole applications.

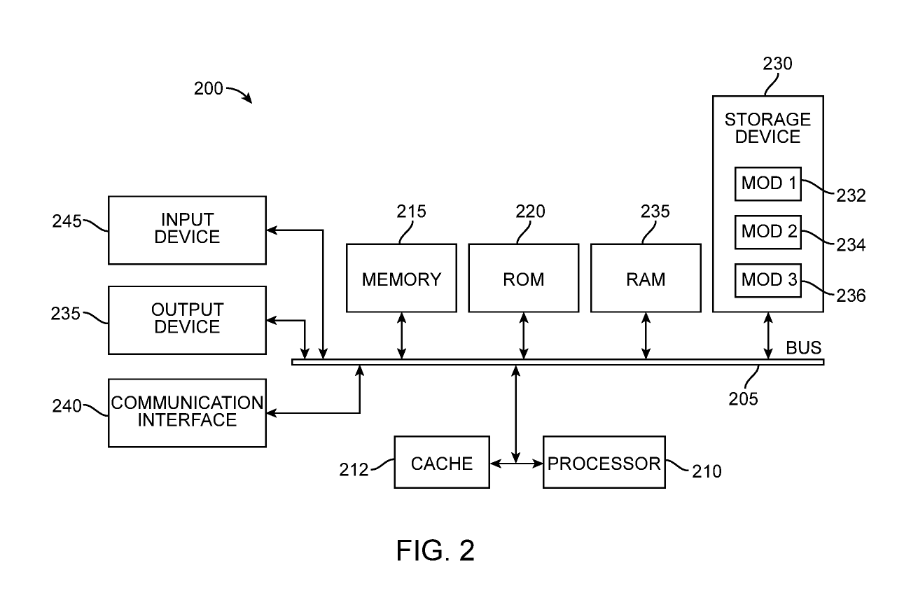

A brief description of a basic general purpose system or computing device in FIG. 2 which can be employed to practice the concepts, methods, and techniques disclosed herein is illustrated. With reference to FIG. 2, an exemplary system and/or computing device 800 includes a processing unit (CPU or processor) 210 and a system bus 205 that coupled various system components including the system memory 215 such as read only memory (ROM) 220 and random access memory (RAM) 235 to the processor 210. The processors of FIGS. 1A-1B (for example, the first processor 102 and the second processor 104) can all be forms of this processor 210. The system 200 can include a cache 212 of high-speed memory connected directly with, in close proximity to, or integrated as part of the processor 210. The system 200 copies data from the memory 215 and/or the storage device 230 to the cache 212 for quick access by the processor 210. In this way, the cache provides a performance boost that avoids processor 210 delays while waiting for data. These and other modules can control or be configured to control the processor 210 to perform various operations or actions. Other system memory 215 may be available for use as well. The memory 215 can include multiple different types of memory with different performance characteristics. It can be appreciated that the disclosure may operate on a computing device 200 with more than one processor 210 or on a group or cluster of computing devices networked together to provide greater processing capability. The processor 210 can include any general purpose processor and a hardware module or software module, such as modulel 232, module 2 234, and module 3 236 stored in storage device 230, configured to control the processor 210 as well as a special-purpose processor where software instructions are incorporated into the processor. The processor 210 may be a self-contained computing system, containing multiple cores or processors, a bus, memory controller, cache, etc. A multi-core processor may be symmetric or asymmetric. The processor 210 can include multiple processors, such as a system having multiple, physically separate processors in different sockets, or a system having multiple processor cores on a single physical chip. Similarly, the processor 210 can include multiple distributed processors located in multiple separate computing devices but working together such as via a communications network. Multiple processors or processor cores can share resources such as memory 215 or the cache 212, or can operate using independent resources. The processor 210 can include one or more of a state machine, an application specific integrated circuit (ASIC), or a programmable gate array (PGA) including a field PGA.

The system bus 205 may be any of several types of bus structures including a memory bus or memory controller, a peripheral bus, and a local bus using any of a variety of bus architectures. A basic input/output (BIOS) stored in ROM 220 or the like, may provide the basic routine that helps to transfer information between elements within the computing device 200, such as during start-up. The computing device 200 further includes storage devices 230 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 230 can include software modules 232, 234, 236 for controlling the processor 210. The system 200 can include other hardware or software modules. The storage device 230 is connected to the system bus 205 by a drive interface. The drives and the associated computer-readable storage devices provide nonvolatile storage of computer-readable instructions, data structures, program modules, and other data for the computing device 200. In one aspect, a hardware module that performs a particular function includes the software component stored in a tangible computer-readable storage device in connection with the necessary hardware components, such as the processor 210, bus 205, display, and so forth, to carry out a particular function. In another aspect, the system can use a processor and computer-readable storage device to store instructions which, when executed by the processor, cause the processor to perform operations, a method, or other specific actions. The basic components and appropriate variations can be modified depending on the type of device, such as whether the device 200 is a small, handheld computing device, a desktop computer, a computer server, a fluid analysis tool, or a separate device provided downhole. When the processor 210 executes instructions to perform “operations”, the processor 210 can perform the operations directly and/or facilitate, direct, or cooperate with another device or component to perform the operations.

Although the exemplary embodiment(s) described herein employs the hard disk 230, other types of computer-readable storage devices which can store data that are accessible by a computer, such as magnetic cassettes, flash memory cards, digital versatile disks (DVDs), cartridges, random access memories (RAMs) 235, read only memory (ROM 220, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 200, an input device represents any number of input mechanisms such as a microphone for speech, a touch sensitive screen for gesture or graphical input, keyboard, mouse, motion input, speech, and so forth. An output device 235 can also be one or more of a number of output mechanisms known to those of skill in the art. In some instances, multimodal systems enable a user to provide multiple types of input to communicate with the computing device 200. The communications interface 240 generally governs and manages the user input and system output. There is no restriction on operating on any particular hardware arrangement and therefore the basic hardware depicted may easily be substituted for improved hardware or firmware arrangements as they are developed.

For clarity of explanation, an illustrative system embodiment is presented as including individual functional blocks including functional blocks labeled as a “processor” or processor 210. The functions these blocks represent may be provided through the use of either shared or dedicated hardware, including, but not limited to, hardware capable of executing software and hardware, such as a processor 210, that is purpose-built to operate as an equivalent to software executing on a general purpose processor. For example, the functions of one or more processors presented in FIG. 2 may be provided by a single shared processor or multiple processors. (Use of the term “processor” should not be construed to refer exclusively to hardware capable of executing software.) Illustrative examples may include microprocessor and/or digital signal processor (DSP) hardware, ROM 220 for storing software performing the operations described below, and RAM 235 for storing results. Very large scale integration (VLSI) hardware embodiments, as well as custom VLSI circuitry in combination with a general purpose DSP circuit, may also be provided.

The logical operations of the various examples are implemented as: (1) a sequence of computer implemented steps, operations, or procedures running on a programmable circuit within a general use computer, (2) a sequence of computer implemented steps, operations, or procedures running on a specific-use programmable circuit, and/or (3) interconnected machine modules or program engines within the programmable circuits. The system 200 shown in FIG. 2 can practice all or part of the recited methods, can be a part of the recited systems, and/or can operate according to instructions in the recited tangible computer-readable storage devices. Such logical operations can be implemented as modules configured to control the processor 210 to perform particular functions according to the programming f the module. For example, FIG. 2 illustrates three modules Mod1 232, Mod2 234, and Mod3 236 which are modules configured to control the processor 210. These modules may be stored on the storage device 230 and loaded into RAM 235 or memory 215 at runtime or may be stored in other computer-readable memory locations.

One or more parts of the example computing device 200, up to and including the entire computing device 200, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately, however, virtualized hardware of every type of implemented or executed by some underlying physical hardware. Thus, a virtualization compute layer can operate on top of a physical compute layer. The virtualization compute layer can include one or more of a virtual machine, an overlay network a hypervisor, virtual switching, and any other virtualization application.

The processor 210 can include all types of processors disclosed herein, including a virtual processor. However, when referring to a virtual processor, the processor 210 includes the software components associated with executing the virtual processor in a virtualization layer and underlying hardware necessary to execute the virtualization layer. The system 200 can include a physical or virtual processor 210 that receives instructions stored in a computer-readable storage device, which cause the processor 210 to perform certain operations. When referring to a virtual processor 210, the system also includes the underlying physical hardware executing the virtual processor 210.

Examples within the scope of the present disclosure may also include tangible and/or non-transitory computer-readable storage devices for carrying or having computer-executable instructions or data structures stored thereon. Such tangible computer-readable storage devices can be any available device that can be accessed by a general purpose or special purpose computer, including the functional design of any special purpose processor as described herein. By way of example, and not limitation, such tangible computer-readable devices can include RAM, ROM, EEPROM, CD-ROM, or other optical disk storage, magnetic disk storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions associated data structures, and program modules represent examples of the program code means for executing steps of the methods disclosed herein. The particular sequence of such executable instructions of associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage device.

The disclosure now turns to a discussion of building an ANFIS model using SARA concentration, lumped chemical concentration from C1 to C5 hydrocarbons (C1-C5 hydrocarbon concentration), gas:oil ratio (GOR), positive correlated saturates (SAT-POS), and negative correlated saturates (SAT-NEG) as example properties. The disclosure is not limited to the properties used herein. The SAT-POS and SAT-NEG can be responses obtained by fluid sensors with broadband filters such as the HALLIBURTON® ICE CORE® sensors and calculated as a dot product of calibration fluid spectroscopy data and the wheel spectrum of each sensor.

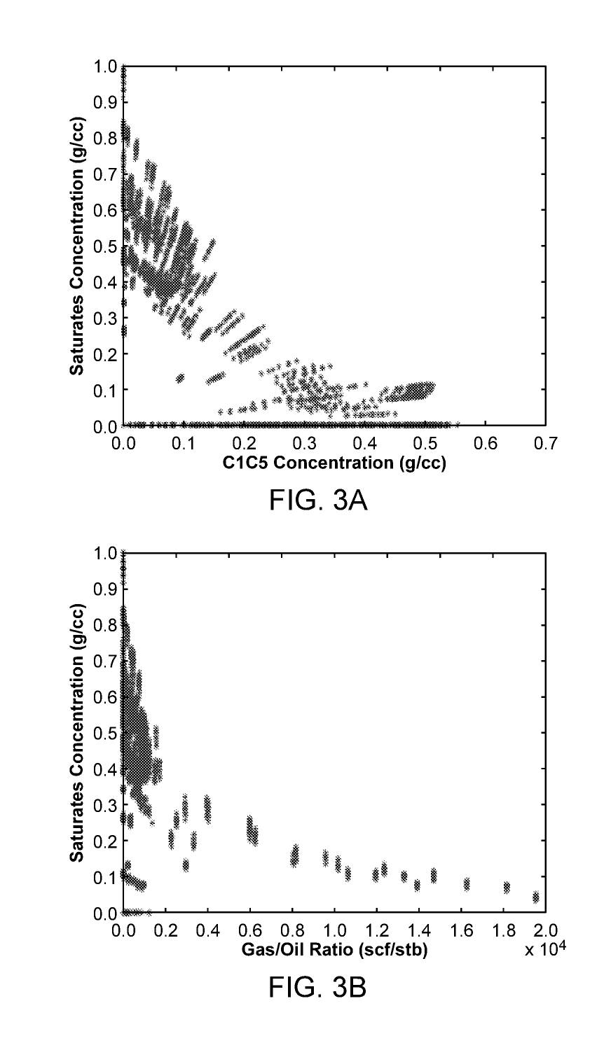

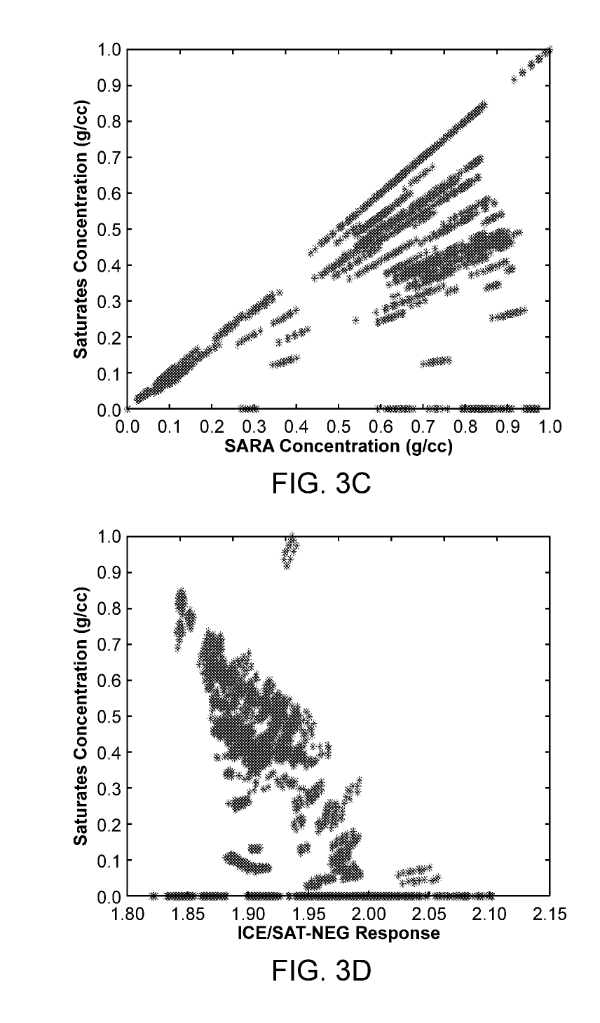

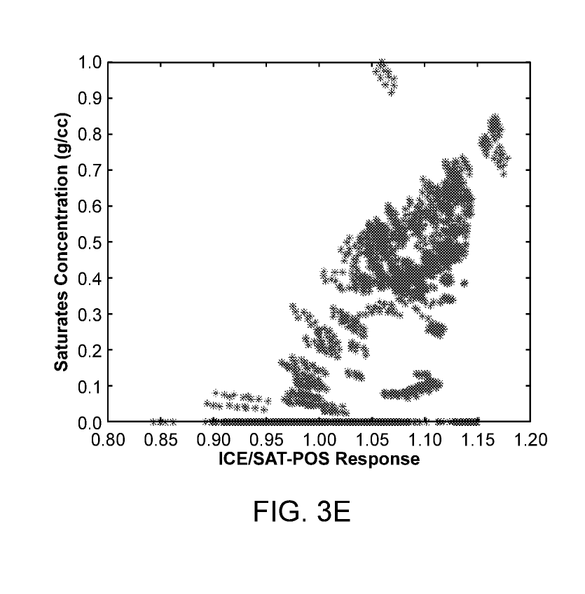

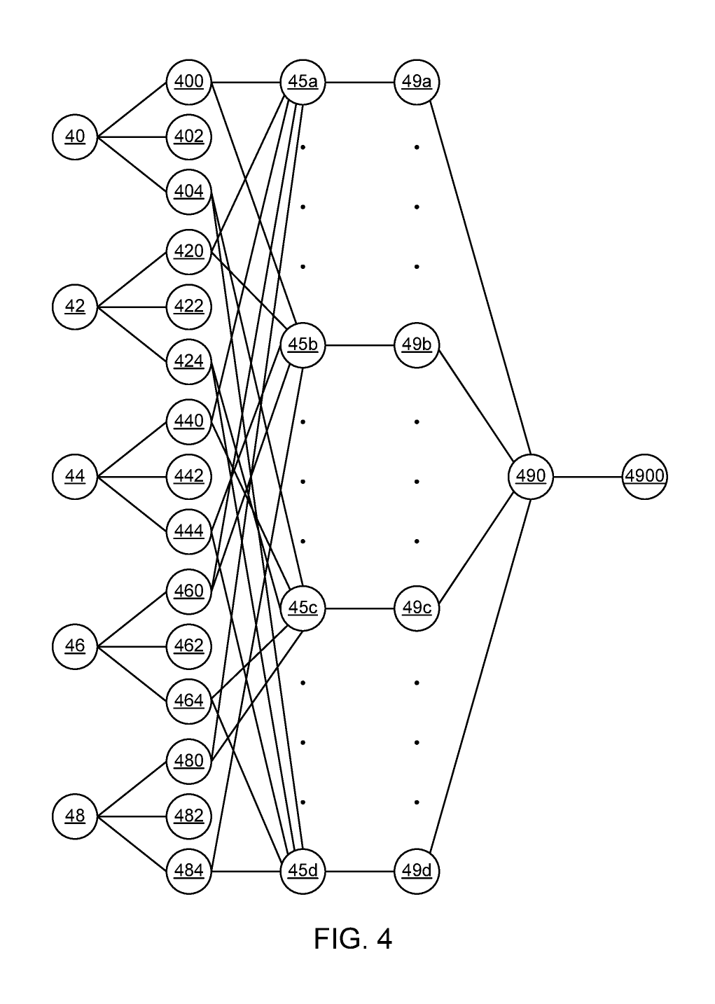

FIGS. 3A-3E illustrate exemplary cross plots of each property against the concentration of saturates to be predicted from an exemplary database comprising about 2300 fluid samples. FIG. 3A shows the cross plot for C1-C5 hydrocarbon concentration, FIG. 3B shows the cross plot for GOR, FIG. 3C shows the cross plot for SARA concentration, FIG. 3D shows the cross plot for SAT-NEG, and FIG. 3E shows the cross plot for SAT-POS. As can be seen in the cross plots, each individual property alone does not provide an adequate correlation to serve as a predictor in characterizing the downhole fluid.

FIG. 4 illustrates an exemplary ANFIS model structure with five inputs and a single output. ANFIS is a model that maps input properties 40, 42, 44, 46, 48 to input membership functions (MFs) 400, 402, 404, 420, 422, 424, 440, 442, 444, 460, 462, 464, 480, 482, 484; the membership functions 400, 402, 404, 420, 422, 424, 440, 442, 444, 460, 462, 464, 480, 482, 484 are mapped to rules 45a, 45b, 45c, 45d, the rules 45a, 45b, 45c, 45d to output membership functions 49a, 49b, 49c, 49d, and output membership functions 49a, 49b, 49c, 49d to a single valued, aggregated output 490 or a defuzzified output 4900. Through training, the ANFIS model can learn from data with membership function parameters adjusted using a back propagation algorithm in combination with a least squares type of method to minimize the calibration error.

Each input property relates to a property that can be measured by a fluid sensor or found in a database. For example, in FIG. 4, the input properties 40, 42, 44, 46, 48 can correspond to lumped chemical concentration from C1-C5 hydrocarbons 40, gas:oil ratio (GOR) 42, SARA concentration 44, negative correlated saturates (SAT-NEG) 46, and positive correlated saturates (SAT-POS) 48. Three membership functions are selected for each input property 40, 42, 44, 46, 48 to define low, medium, and high. For example, input property 40 has three input membership functions 400, 402, 404; input property 42 relates to membership functions 420, 422, 424; and input property 44 relates to membership functions 440, 442, 444. In other examples, each input property corresponds to two, four, five, or more membership functions. For input variable x, the membership function μ(x) with a maximum degree equal to 1 and a minimum degree equal to 0, called fuzzy sets, can be calculated in equation (1) which is dependent on three parameters a, b, and c:

$$u ( x ) = \frac{1}{1 + {\vert ( x - c ) \text{/} a \vert}^{2 b}} \qquad ( 1 )$$

In FIG. 4, there are 15 nodes representing all of the membership functions 400, 402, 404, 420, 422, 424, 440, 442, 444, 460, 462, 464, 480, 482, 484, relating to the all of the input properties 40, 42, 44, 46, 48, where membership functions 400, 420, 440, 460, 480 are defined as low, membership functions 402, 422, 442, 462, 482 are defined as medium, and membership functions 404, 424, 444, 464, 484 are defined as high. The number of non-linear parameters of a, b, and c in equation (1) for membership functions can be 45, which can also be optimized through training.

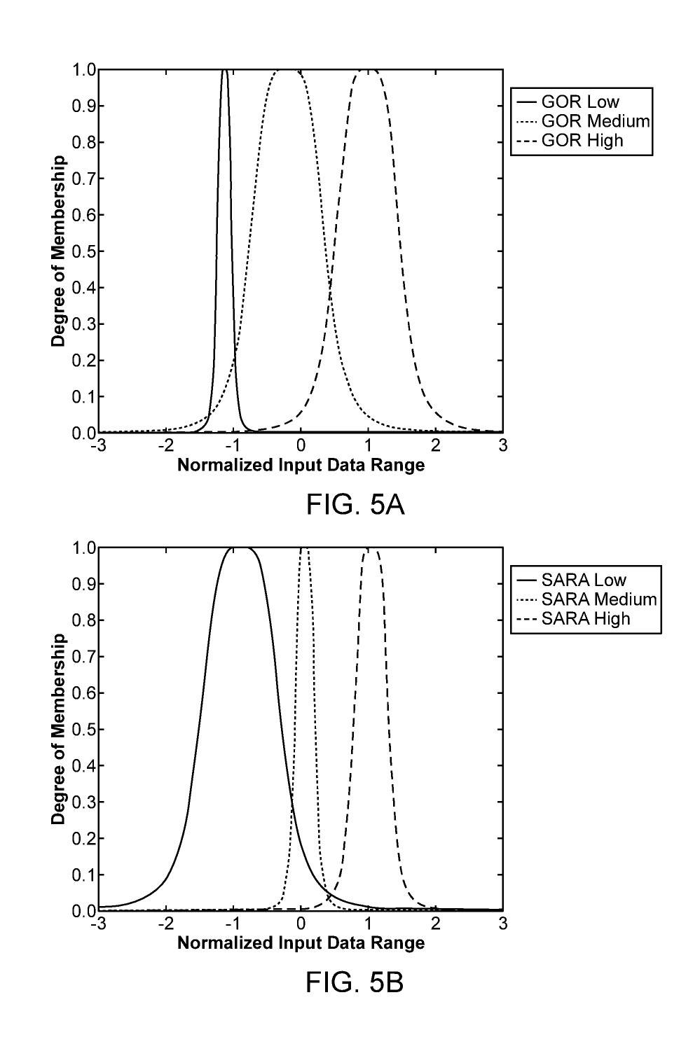

FIGS. 5A and 5B are exemplary graphs which show resulting membership functions for GOR and SARA calculated from equation (1) above. The normalized effective data range in this example is from −1 to 1. While this example utilizes bell-shaped membership functions, in other examples, other membership functions can be used such as Gaussian curve membership functions, triangular membership functions, or any other suitable membership functions. For an ANFIS model structure of 5 inputs with 3 membership functions for each input, there are a total of 3⁵, or 243, different combinations of fuzzy sets which can be coded as antecedent to build fuzzy rules. For example, code [1 1 3 1 3] represents the antecedent or if statement of rule 45b in FIG. 4. Code [1 1 3 1 3] can be interpreted as: if (input 40 is MF 400) and (input 42 is MF 420) and (input 44 is MF 444) and (input 46 is MF 460) and (input 48 is MF 484). For example, if C1-C5 hydrocarbon concentration is low, GOR is low, SARA is high, SAT-NEG is low, and SAT-POS is high are all true with high degree, then there may be heavy oil which relates to rule 45b. For another example, code [3 3 1 3 1] represents the antecedent or if statement of rule 45c, where code [3 3 1 3 1] can be interpreted as: if (input 40 is MF 404) and (input 42 is MF 424) and (input 44 is MF 440) and (input 46 is MF 464) and (input 48 is MF 480). In other words: if C1-C5 hydrocarbon concentration is high, GOR is high, SARA is low, SAT-NEG is high, and SAT-POS is low are all true with high degree, then there may be gas or gas condensates which relates to rule 45c.

The consequence or then statement of rule 45b and rule 45c is the output membership function (output MF) corresponding to the same rule number (see output MF 49b and output MF 49c in FIG. 4) which is a linear combination of input calculated by equations (2) and (3) below:

f_{45b}=g_{45b}×Input40+h_{45b}×Input42+k_{45b}×Input44+p_{45b}×Input46+q_{45b}×Input48+r_{45b} (2)

f_{45c}=g_{45c}×Input40 +h_{45c}×Input42+k_{45c}×Input44+p_{45c}×Input46+q_{45c}×Input48 +r_{45c} (3)

In exemplary equations (2) and (3), parameter set g, h, k, p, q, and r for each rule can be optimized through training. In this example, there are 243×6 or 1458 possible linear parameters. The overall number of possible parameters, which include both nonlinear and linear parameters, can be 1503 which can be implemented in a processor after the ANFIS model is built.

The aggregated output 490 of the ANFIS model in FIG. 4 can be calculated as Σᵢ₌₁²⁴³wᵢfᵢ, where wᵢ is calculated by equation (4) below:

wᵢ=μ_{A}_{ᵢ}(Input40)×μ_{B}_{ᵢ}(Input42)×μ_{C}_{ᵢ}(Input44)×μ_{D}_{ᵢ}(Input46)×μ_{E}_{ᵢ}(Input48) (4)

where μp_{Ai,} μ_{Bi,} μ_{Ci,} μ_{Di,} and μ_{Ei} are degree of membership for Input 40, Input 42, Input 44, Input 46, and Input 48 respectively dependent to the antecedent of each rule. The defuzzified output 4900 in FIG. 4 is a weighted average provided by FIG. 5 below:

$$Ouput = \frac{{\sum }_{i = 1}^{243} {w}_{i} {f}_{i}}{{\sum }_{i = 1}^{243} {w}_{i}} \qquad ( 5 )$$

In FIG. 4, the rules 45a, 45b, 45c, 45d are antecedent dependent such that no rule is shared with more than one antecedent. Some antecedents, for example where all the inputs 40, 42, 44, 46, 48 have high MFs 404, 424, 444, 464, 484 leading to rule 45d, will have a very low degree in equation (4), thereby having less effect while calculating the defuzzified output 4900. The ANFIS model can be used for modeling nonlinear systems by interpolating multiple linear models.

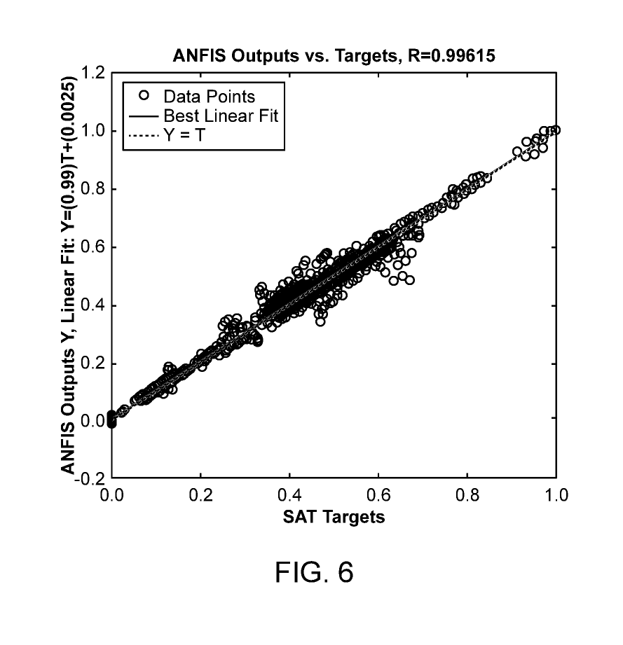

The ANFIS model provides a better correlation between predicted saturate concentration against the training target provided by a database. An exemplary cross plot showing the correlation is provided in FIG. 6.

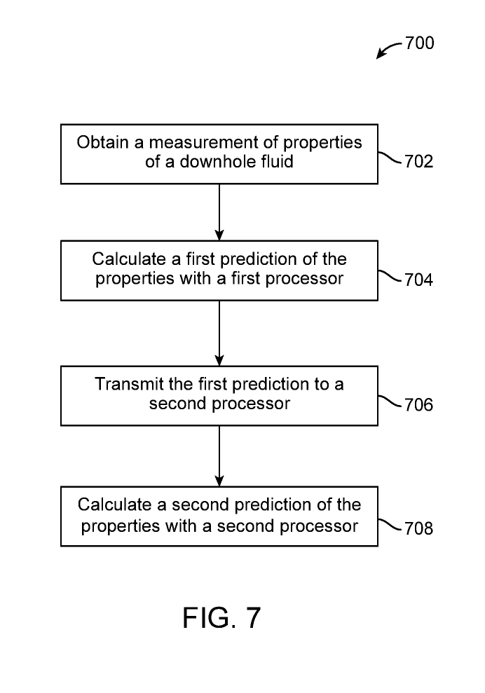

Referring to FIG. 7, a flowchart is presented in accordance with an example embodiment. The method 700 is provided by way of example, as there are a variety of ways to carry out the method. The method 700 described below can be carried out using the configurations illustrated in FIGS. 1A-6, for example, and various elements of these figures are referenced in explaining example method 700. Each block shown in FIG. 7 represents one or more processes, methods or subroutines, carried out in the example method 700. Furthermore, the illustrated order of blocks is illustrative only and the order of the blocks can change according to the present disclosure. Additional blocks may be added or fewer blocks may be utilized, without departing from this disclosure. The example method 700 can begin at block 702.

At block 702, a measurement of one or more properties of a downhole fluid is obtained by a fluid analysis tool. The fluid analysis tool can be a HALLIBURTON® RDT™. The measurement can be taken by one or more fluid sensors in the fluid analysis tool. The fluid sensors can be optical sensors. In at least one example, the fluid sensors can have analyte specific broadband filters, for example HALLIBURTON® ICE CORE® sensors. The one or more properties of the downhole fluid can be C1-C5 hydrocarbon concentration, gas:oil ratio, sum of SARA concentration, positive correlated saturates, or negative correlated saturates, among other characteristics of the downhole fluid.

The fluid analysis tool further includes a first processor communicatively coupled with the fluid sensors. In at least one example, the first processor uses a neural network ensemble. The fluid analysis tool includes a first non-transitory computer-readable storage medium which stores first instructions that are executed by the first processor. Along with the first processor, the fluid analysis tool also includes a second processor which is communicatively coupled with a second non-transitory computer-readable storage medium. The second processor can also be coupled with the fluid sensors. The second non-transitory computer-readable storage medium stores second instructions that are executed by the second processor. The second non-transitory computer-readable storage medium can also be communicatively coupled with the first processor. The first processor and second processor can be communicatively coupled with the same computer-readable storage medium which can hold processed data or send processed data to either and both of the first and second processors. The second processor uses an adaptive neuro-fuzzy inference system (ANFIS).

The measurement taken by the fluid sensors is transmitted to the first processor where, at block 704, the first processor calculates a first prediction of the properties of the downhole fluid using the measurement. The first prediction includes an estimate of the fluid compositions and properties of the downhole fluid.

At block 706, the first prediction is transmitted from the first processor to the second processor. The first prediction can be stored in the second non-transitory computer-readable storage medium which can be accessed by the second processor. In other examples, the first prediction can be transmitted from the first processor to the second processor by any suitable method such as fiber optic communication.

At block 708, the second processor, using the ANFIS, calculates a second prediction of the properties of the downhole fluid using the first prediction of the properties from the fluid sensors, thereby providing a more accurate prediction of the downhole fluid without post-processing. The second non-transitory computer-readable storage medium can also store a database of fluid data, for example an optical-PVT (pressure-temperature-volume) database. The second processor can use the first prediction with the database to calculate the second prediction. In at least one example, the second processor is also communicatively coupled to the fluid sensors and uses measurements from the fluid sensors of the downhole fluid in calculating the second prediction. In at least one example, the first prediction and the second prediction are calculated in real time while the fluid analysis tool is downhole.

In other examples, a processor can determine which properties of the first prediction need to be enhanced by the second processor. Those properties that need enhancement can be called low-uncertainty inputs. The processor determines which of the properties of the prediction the low-uncertainty inputs are by considering many factors such as the sum of the density components, the ratio of SARA components, and other suitable factors. Once the low-uncertainty inputs are determined, the second processor uses the ANFIS to calculate a second prediction of the low-uncertainty inputs to enhance the first prediction. The second prediction can be stored on a non-transitory computer-readable storage medium. The second prediction can be transmitted uphole. In at least one example, the second prediction can be stored on a non-transitory computer-readable storage medium uphole.

Numerous examples are provided herein to enhance understanding of the present disclosure. A specific set of statements are provided as follows.

Statement 1: A method comprising: obtaining, at one or more fluid sensors of a fluid analysis tool in a wellbore, a measurement of one or more properties of a downhole fluid, the fluid sensors communicatively coupled with one or more processors; generating, at the one or more processors, a first prediction of the one or more properties using the measurement from the one or more fluid sensors; generating a second prediction of the one or more properties of the downhole fluid using an adaptive neuro-fuzzy inference system (ANFIS) based on the first prediction of the one or more properties; and storing the second prediction on one or more non-transitory computer-readable storage media.

Statement 2: A method is disclosed according to Statement 1, wherein the first prediction is generated based on a neural network ensemble.

Statement 3: A method is disclosed according to Statements 1 or 2, wherein the first prediction and the second prediction are generated in real time.

Statement 4: A method is disclosed according to any of preceding Statements 1-3, wherein the one or more fluid sensors are optical sensors.

Statement 5: A method is disclosed according to Statement 4, wherein the optical sensors are analyte specific broadband filters.

Statement 6: A method is disclosed according to any of preceding Statements 1-5, wherein the one or more properties are selected from one or more of C1-C5 hydrocarbon concentration, gas:oil ratio, sum of SARA (saturates, aromatics, resins, and asphaltenes) concentration, positive correlated saturates, and negative correlated saturates.

Statement 7: A method is disclosed according to any of preceding Statements 1-6, wherein the one or more non-transitory computer-readable storage media has instructions stored which are executed by the one or more processors; wherein the one or more non-transitory computer-readable storage media stores fluid data, wherein the ANFIS of the one or more processors generates the second prediction with the fluid data from the one or more non-transitory computer-readable storage media and the first prediction.

Statement 8: A method is disclosed according to any of preceding Statements 1-7, wherein the one or more non-transitory computer-readable storage media has instructions stored which are executed by the one or more processors; wherein the one or more non-transitory computer-readable storage media stores fluid data; wherein the ANFIS of the one or more processors generates the second prediction with the fluid data from the one or more non-transitory computer-readable storage media and the measurement of the one or more properties from the one or more fluid sensors.

Statement 9: A method is disclosed according to any of preceding Statements 1-8, further comprising: receiving, via the one or more non-transitory computer-readable storage media from the one or more processors, data comprising the first prediction; and storing, via the one or more non-transitory computer-readable storage media, the data comprising the first prediction.

Statement 10: A method is disclosed according to any of preceding Statements 1-9, further comprising: transmitting the second prediction uphole.

Statement 11: A fluid analysis tool comprising: one or more fluid sensors; one or more processors communicatively coupled with the one or more fluid sensors; and one or more non-transitory computer-readable storage media having instructions stored which when executed by the one or more processors, cause the one or more processors to: generate a first prediction based on a measurement of one or more properties of a downhole fluid obtained by the one or more fluid sensors; generate a second prediction of the one or more properties of the downhole fluid using an adaptive neuro-fuzzy inference system (ANFIS) based on the first prediction of the one or more properties; and store the second prediction on the one or more non-transitory computer-readable storage media.

Statement 12: A fluid analysis tool is disclosed according to Statement 11, wherein the first prediction is generated based on a neural network ensemble.

Statement 13: A fluid analysis is disclosed according to Statements 11 or 12, wherein the first prediction and the second prediction are generated in real time.

Statement 14: A fluid analysis tool is disclosed according to any of preceding Statements 11-13, wherein the one or more fluid sensors are optical sensors.

Statement 15: A fluid analysis tool is disclosed according to Statement 14, wherein the optical sensors are analyte specific broadband filters.

Statement 16: A fluid analysis tool is disclosed according to any of preceding Statements 11-15, wherein the one or more properties are selected from one or more of C1-C5 hydrocarbon concentration, gas:oil ratio, sum of SARA (saturates, aromatics, resins, and asphaltenes) concentration, positive correlated saturates, and negative correlated saturates.

Statement 17: A fluid analysis tool is disclosed according to any of preceding Statements 11-16, wherein the one or more non-transitory computer-readable storage media stores fluid data; wherein the ANFIS of the one or more processors generates the second prediction with the fluid data from the one or more non-transitory computer-readable storage media and the first prediction.

Statement 18: A fluid analysis tool is disclosed according to any of preceding Statements 11-17, wherein the one or more non-transitory computer-readable storage media stores fluid data; wherein the ANFIS of the one or more processors generates the second prediction with the fluid data from the one or more non-transitory computer-readable storage media and the measurement of the one or more properties from the one or more fluid sensors.

Statement 19: A fluid analysis tool is disclosed according to any of preceding Statements 11-18, further comprising: receiving, via the one or more non-transitory computer-readable storage media from the one or more processors, data comprising the first prediction; and storing, via the one or more non-transitory computer-readable storage media, the data comprising the first prediction.

Statement 20: A fluid analysis tool is disclosed according to any of preceding Statements 11-19, further comprising: transmitting the second prediction uphole.

Statement 21: A non-transitory computer-readable storage medium having instructions stored which, when executed by a computing device, cause the computer device to perform operations comprising: obtaining, at one or more fluid sensors of a fluid analysis tool in a wellbore, a measurement of one or more properties of a downhole fluid, the fluid sensors communicatively coupled with one or more processors; generating a first prediction of the one or more properties using the measurement from the one or more fluid sensors; generating a second prediction of the one or more properties of the downhole fluid using an adaptive neuro-fuzzy inference system (ANFIS) based on the first prediction of the one or more properties; and storing the second prediction on one or more non-transitory computer-readable storage media.

Statement 22: A non-transitory computer-readable storage medium is disclosed according to Statement 21, wherein the first prediction is generated based on a neural network ensemble.

Statement 23: A non-transitory computer-readable storage medium is disclosed according to Statements 21 or 22, wherein the first prediction and the second prediction are generated in real time.

Statement 24: A non-transitory computer-readable storage medium is disclosed according to any of preceding Statements 21-23, wherein the one or more fluid sensors are optical sensors.

Statement 25: A non-transitory computer-readable storage medium is disclosed according to Statement 24, wherein the optical sensors are analyte specific broadband filter.

Statement 26: A non-transitory computer-readable storage medium is disclosed according to any of preceding Statements 21-25, wherein the one or more properties are selected from one or more of C1-C5 hydrocarbon concentration, gas:oil ratio, sum of SARA (saturates, aromatics, resins, and asphaltenes) concentration, positive correlated saturates, and negative correlated saturates.

Statement 27: A non-transitory computer-readable storage medium is disclosed according to any of preceding Statements 21-26, wherein the one or more non-transitory computer-readable storage media has instructions stored which are executed by the one or more processors; wherein the one or more non-transitory computer-readable storage media stores fluid data, wherein the ANFIS of the one or more processors generates the second prediction with the fluid data from the one or more non-transitory computer-readable storage media and the first prediction.

Statement 28: A non-transitory computer-readable storage medium is disclosed according to any of preceding Statements 21-27, wherein the one or more non-transitory computer-readable storage media has instructions stored which are executed by the one or more processors; wherein the one or more non-transitory computer-readable storage media stores fluid data; wherein the ANFIS of the one or more processors generates the second prediction with the fluid data from the one or more non-transitory computer-readable storage media and the measurement of the one or more properties from the one or more fluid sensors.

Statement 29: A non-transitory computer-readable storage medium is disclosed according to any of preceding Statements 21-28, further comprising: receiving, via the one or more non-transitory computer-readable storage media from the one or more processors, data comprising the first prediction; and storing, via the one or more non-transitory computer-readable storage media, the data comprising the first prediction.

Statement 30: A non-transitory computer-readable storage medium is disclosed according to any of preceding Statements 21-29, further comprising: transmitting the second prediction uphole.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. A method comprising:
obtaining, at one or more fluid sensors of a fluid analysis tool in a wellbore, a measurement of one or more properties of a downhole fluid, the fluid sensors communicatively coupled with one or more processors;
generating, at the one or more processors, a first prediction of the one or more properties using the measurement from the one or more fluid sensors;
generating a second prediction of the one or more properties of the downhole fluid using an adaptive neuro-fuzzy inference system (ANFIS) based on the first prediction of the one or more properties; and
storing the second prediction on one or more non-transitory computer-readable storage media.

2. The method of claim 1, wherein the first prediction is generated based on a neural network ensemble.

3. The method of claim 1, wherein the first prediction and the second prediction are generated in real time.

4. The method of claim 1, wherein the one or more fluid sensors are optical sensors.

5. The method of claim 4, wherein the optical sensors are analyte specific broadband filters.

6. The method of claim 1, wherein the one or more properties are selected from one or more of C1-C5 hydrocarbon concentration, gas:oil ratio, sum of SARA (saturates, aromatics, resins, and asphaltenes) concentration, positive correlated saturates, and negative correlated saturates.

7. The method of claim 1, wherein the one or more non-transitory computer-readable storage media has instructions stored which are executed by the one or more processors; wherein the one or more non-transitory computer-readable storage media stores fluid data, wherein the ANFIS of the one or more processors generates the second prediction with the fluid data from the one or more non-transitory computer-readable storage media and the first prediction.

8. The method of claim 1, wherein the one or more non-transitory computer-readable storage media has instructions stored which are executed by the one or more processors; wherein the one or more non-transitory computer-readable storage media stores fluid data; wherein the ANFIS of the one or more processors generates the second prediction with the fluid data from the one or more non-transitory computer-readable storage media and the measurement of the one or more properties from the one or more fluid sensors.

9. The method of claim 1, further comprising:
receiving, via the one or more non-transitory computer-readable storage media from the one or more processors, data comprising the first prediction; and
storing, via the one or more non-transitory computer-readable storage media, the data comprising the first prediction.

10. The method of claim 1, further comprising: transmitting the second prediction uphole.

11. A fluid analysis tool comprising:
one or more fluid sensors;
one or more processors communicatively coupled with the one or more fluid sensors; and
one or more non-transitory computer-readable storage media having instructions stored which when executed by the one or more processors, cause the one or more processors to:
generate a first prediction based on a measurement of one or more properties of a downhole fluid obtained by the one or more fluid sensors;
generate a second prediction of the one or more properties of the downhole fluid using an adaptive neuro-fuzzy inference system (ANFIS) based on the first prediction of the one or more properties; and
store the second prediction on the one or more non-transitory computer-readable storage media.

12. The fluid analysis tool of claim 11, wherein the first prediction is generated based on a neural network ensemble.

13. The fluid analysis tool of claim 11, wherein the first prediction and the second prediction are generated in real time.

14. The fluid analysis tool of claim 11, wherein the one or more fluid sensors are optical sensors.

15. The fluid analysis tool of claim 14, wherein the optical sensors are analyte specific broadband filters.

16. The fluid analysis tool of claim 11, wherein the one or more properties are selected from one or more of C1-C5 hydrocarbon concentration, gas:oil ratio, sum of SARA (saturates, aromatics, resins, and asphaltenes) concentration, positive correlated saturates, and negative correlated saturates.

17. The fluid analysis tool of claim 11, wherein the one or more non-transitory computer-readable storage media stores fluid data; wherein the ANFIS of the one or more processors generates the second prediction with the fluid data from the one or more non-transitory computer-readable storage media and the first prediction.

18. The fluid analysis tool of claim 11, wherein the one or more non-transitory computer-readable storage media stores fluid data; wherein the ANFIS of the one or more processors generates the second prediction with the fluid data from the one or more non-transitory computer-readable storage media and the measurement of the one or more properties from the one or more fluid sensors.

19. The fluid analysis tool of claim 11, further comprising:
receiving, via the one or more non-transitory computer-readable storage media from the one or more processors, data comprising the first prediction; and
storing, via the one or more non-transitory computer-readable storage media, the data comprising the first prediction.

20. A non-transitory computer-readable storage medium having instructions stored which, when executed by a computing device, cause the computing device to perform operations comprising:
obtaining, at one or more fluid sensors of a fluid analysis tool in a wellbore, a measurement of one or more properties of a downhole fluid, the fluid sensors communicatively coupled with one or more processors;
generating a first prediction of the one or more properties using the measurement from the one or more fluid sensors;
generating a second prediction of the one or more properties of the downhole fluid using an adaptive neuro-fuzzy inference system (ANFIS) based on the first prediction of the one or more properties; and
storing the second prediction on one or more non-transitory computer-readable storage media.
